(19) United States
(12) Patent Application Publication
(10) Pub. No.: US 2007/0066762 A1
(43) Pub. Date: Mar. 22, 2007

(54) Triazole-containing fluorinated polymers

(76) Inventors: Erick Jose Acosta, New Castle, DE (US); Peter Michael Murphy, Chadds Ford, PA (US); Andrew Joseph McCall, Marlton, NJ (US); John Christopher Sworen, Chadds Ford, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/233,320

(22) Filed: Sep. 22, 2005

(51) Int. Cl. C08F 120/10

(52) U.S. Cl. 525/330.3

(57) ABSTRACT

A copolymer for imparting repellency and stain resistance to substrates is disclosed of Formula 1
[R_{f}—X₁-A-X₁—Y—C(O)—CZCH₂]ₘ—[W_{q}]ₚ Formula 1 wherein
R_{f} is a straight or branched perfluoroalkyl group having from about 2 to about 20 carbon atoms, or a mixture thereof, which is optionally interrupted by at least one oxygen atom,
each X₁ is independently an organic divalent linking group having from about 1 to about 20 carbon atoms, optionally containing a triazole, oxygen, nitrogen, or sulfur, or a combination thereof, A is a 1,2,3-triazole,
Y is O or N(R)₂ wherein R is H or C₁ to C₂₀ alkyl, Z is H, a straight or branched alkyl group having from about 1 to about 4 carbon atoms, or halide, m is a positive integer, q is zero or a positive integer, p is zero or a positive integer, and
   W is 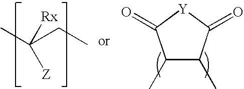
   or [R¹—X₁—Y—C(O)—CH₂Z], wherein
X₁, Y, and Z are as defined above,
Rx is C(O)O(R¹), C(O)N(R²)₂, OC(O)(R¹), SO₂(R¹), C₆(R³)₅, O(R¹), halide, or R¹;
each R¹ is independently H, CₙH₂ₙ₊₁, CₙH₂ₙ—CH(O)CH₂, [CH₂CH₂O]ᵢR⁴, [CₙC₂ₙ]N(R⁴)₂ or [CₙH₂ₙ]CₙF₂ₙ₊₁, n is 1 to 40,
R⁴is H or CₛH₂ₛ₊₁, s=0 to 40, i=1 to 200,
each R² is independently H, or CₜH₂ₜ₊₁ wherein t is 1 to 20,
each R³ is independently H, COOR¹, halogen, N(R¹)₂, OR¹, SO₂NHR¹, CH═CH₂, or SO₃M, M is H, alkali metal salt, alkaline earth metal salt, or ammonium.

### FIELD OF THE INVENTION

The present invention relates to triazole-containing fluorinated copolymers which impart oil repellency, alcohol repellency, water repellency, soil resistance and stain resistance to treated substrates.

### BACKGROUND OF THE INVENTION

Various compositions are known to be useful as treating agents to provide surface effects to substrates. Surface effects include repellency to moisture, soil, and stains, and other effects, which are particularly useful for fibrous substrates and other substrates such as hard surfaces. Many such treating agents are fluorinated polymers or copolymers.

Various attempts have been made to improve particular surface effects and to increase the fluorine efficiency, i.e., boost the efficiency or performance of treating agents so that lesser amounts of the expensive fluorinated polymer are required to achieve the same level of performance or have better performance using the same level of fluorine. One method is to incorporate blocked isocyanates or melamine resins. However, only limited amounts can be used because these ingredients tend to adversely affect the handle (the feel) of treated fibrous substrates.

Another method is the use of various extender polymers. These are typically hydrocarbon polymers in aqueous emulsions, which are blended with the fluorinated polymer emulsion before application to the substrates. Optionally, the hydrocarbon polymer may also contain a relatively small amount of a fluorinated monomer.

US Patent Application Publication US 2005/0022313 discloses a method of improving light-fade resistance, soil repellency, and water repellency of a post-dyed textile material, comprising the step of: applying to the post-dyed textile material a composition comprising: one or more anti-fading compounds; one or more anti-soiling compounds; one or more silicon-based polymers; and one or more carrier media. The anti-fading compounds are selected from the group consisting of, succinimides, dioic acids, benzoxyoxazin-ones, dibenzoylmethanes, phenylbenzimidazoles, benzoic acids, esters of benzoic acid, esters of cinnamic acid, esters of 2-cyano-3,3-diphenyl-2-propanoic acid, esters of salicylic acid, and combinations thereof.

Most commercially available fluorinated polymers useful as treating agents for imparting repellency to substrates contain predominantly eight or more carbons in the perfluoroalkyl chain to provide the desired repellency properties. It is desirable to reduce the chain length of the perfluoroalkyl groups thereby reducing the amount of fluorine present, while still achieving the same or superior surface effects. There is a need for polymer compositions which significantly improve the repellency and stain resistance of fluorinated polymer treating agents for fibrous substrates and hard surface substrates while using lower levels of fluorine. The present invention provides such compositions.

### SUMMARY OF THE INVENTION

The present invention comprises a composition comprising a copolymer having repeating units in any sequence of Formula 1
[R_{f}—X₁-A-X₁—Y—C(O)—CZCH₂]ₘ—[W_{q}]ₚ Formula 1
wherein

R_{f} is a straight or branched perfluoroalkyl group having from about 2 to about 20 carbon atoms, or a mixture thereof, which is optionally interrupted by at least one oxygen atom,

each X₁ is independently an organic divalent linking group having from about 1 to about 20 carbon atoms, optionally containing a triazole, oxygen, nitrogen, or sulfur, or a combination thereof,

A is a 1,2,3-triazole,

Y is O or N(R)₂ wherein R is H or C₁ to C₂₀ alkyl,

Z is H, a straight or branched alkyl group having from about 1 to about 4 carbon atoms, or halide,

m is a positive integer,

q is zero or a positive integer,

p is zero or a positive integer, and

W is 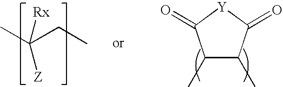
or [R¹—X₁—Y—C(O)—CH₂Z],
   wherein

X₁, Y, and Z are as defined above,

Rx is C(O)O(R¹), C(O)N(R²)₂, OC(O)(R¹), SO₂(R¹), C₆(R³)₅, O(R¹), halide, or R¹;

each R¹ is independently H, CₙH₂ₙ₊₁, CₙH₂ₙ—CH(O)CH₂, [CH₂CH₂O]ᵢR⁴, [CₙC₂ₙ]N(R⁴)₂ or [CₙH₂ₙ]CₙF₂ₙ₊₁,

n is 1 to 40,

R⁴is H or CₛH₂ₛ₊₁,

s=0 to 40,

i=1 to 200,

each R² is independently H, or CₜH₂ₜ₊₁ wherein t is 1 to 20,

each R³ is independently H, COOR¹, halogen, N(R¹)₂, OR¹, SO₂NHR¹, CH═CH₂, or SO₃M,

M is H, alkali metal salt, alkaline earth metal salt, or ammonium.

The present invention further comprises a composition comprising Formula 2
R_{f}—X₁-A-X₁-Y—C(O)C(Z)═CH₂ Formula 2
wherein R_{f}, X₁, A, Y, and Z are each defined as for Formula 1 above.

The present invention further comprises a composition comprising Formula 3
R_{f}—X₁-A-X₁—B Formula 3
wherein R_{f}, X₁, and A are each defined as in Formula 1 above, and B is selected from the group consisting of hydroxyl, amine, halogen, thiol, sulfonyl chloride, and carboxylate, and is preferably hydroxyl or amine.

The present invention further comprises a method of providing repellency and stain resistance to substrates comprising contacting said substrate with a composition of Formula 1 as defined above.

The present invention further comprises substrates treated with a composition of Formula 1 described above.

### DETAILED DESCRIPTION OF THE INVENTION

All trademarks are denoted herein by capitalization. In all instances herein, the term “(meth)acrylate” is used to denote both acrylate or methacrylate.

The present invention comprises triazole-containing fluorinated copolymers which have improved fluorine efficiency. The copolymers are prepared by polymerization of triazole-containing fluorinated acrylic monomers, alkyl(meth)acrylate monomers and optionally other monomers. By “fluorine efficiency” is meant the ability to use a minimum amount of fluorochemical to obtain the desired surface effect, such as repellency properties or stain resistance, when applied to substrates, or to obtain better performance using the same level of fluorine. A copolymer having a high fluorine efficiency generates the same or greater level of surface effect using a lower amount of fluorine than a comparative copolymer.

The copolymers of the present invention comprise Formula 1
[R_{f}—X₁-A-X₁—Y—C(O)—CZCH₂]ₘ—[W_{q}]ₚ Formula 1
wherein

R_{f} is a straight or branched perfluoroalkyl group having from about 2 to about 20 carbon atoms, or a mixture thereof, which is optionally interrupted by at least one oxygen atom,

each X₁ is independently an organic divalent linking group having from about 1 to about 20 carbon atoms, optionally containing a triazole, oxygen, nitrogen, or sulfur, or a combination thereof,

A is a 1,2,3-triazole,

Y is O or N(R)₂ wherein R is H or C₁ to C₂₀ alkyl,

Z is H, a straight or branched alkyl group having from about 1 to about 4 carbon atoms, or halide,

m is a positive integer,

q is zero or a positive integer,

p is zero or a positive integer, and

W is 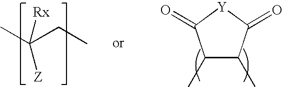
or [R¹—X₁—Y—C(O)—CH₂Z],

wherein

X₁, Y, and Z are as defined above,

Rx is C(O)O(R¹), C(O)N(R²)₂, OC(O)(R¹), SO₂(R¹), C₆(R³)₅, O(R¹), halide, or R¹;

each R¹ is independently H, CₙH₂ₙ₊₁, CₙH₂ₙ—CH(O)CH₂, [CH₂CH₂O]ᵢR⁴, [CₙC₂ₙ]N(R⁴)₂ or [CₙH₂ₙ]CₙF₂ₙ₊₁,

n is 1 to 40,

R⁴ is H or CₛH₂ₛ₊₁,

s=0 to 40,

i=1 to 200,

each R² is independently H, or CₜH₂ₜ₊₁ wherein t is 1 to 20,

each R³ is independently H, COOR¹, halogen, N(R¹)₂, OR¹, SO₂NHR¹, CH═CH₂, or SO₃M,

M is H, alkali metal salt, alkaline earth metal salt, or ammonium.

Preferably R_{f} is a straight or branched perfluoroalkyl group having from about 4 to 20 carbon atoms, more preferably from about 4 to about 12 carbon atoms, or a mixture thereof, optionally interrupted by at least one oxygen atom.

Examples of suitable linking groups X₁ include straight chain, branched chain or cyclic alkylene, phenyl, arylene, aralkylene, sulfonyl, sulfoxy, sulfonamido, carbonamido, carbonyloxy, urethanylene, ureylene, and combinations thereof such as sulfonamidoalkylene.

A is preferably 1,4- or 1,5-disubstituted triazole.

Examples of preferred groups Y are O or N(R)₂ wherein R is H or C₁ to C₄ alkyl;

Preferable m and p are each independently from about 1 to 200.

The copolymers of Formula 1 are prepared by reacting fluorinated (meth)acrylate or nonfluorinated (meth)acrylate with a triazole-containing fluorinated acrylic monomer of Formula 2:
R_{f}—X₁-A-X₁—Y—C(O)C(Z)═CH₂ Formula 2
wherein

R_{f}, X₁, A, Y, and Z are each defined as for Formula 1 above.

The triazole-containing fluorinated acrylic monomer of Formula 2, used in the preparation of the copolymer of Formula 1, is prepared by contacting acrylic acid, acrylate ester, or acryloyl chloride with a triazole-containing fluorochemical of Formula 3:
R_{f}—X₁-A-X₁—B Formula 3
wherein

R_{f}, X₁, and A are each defined as in Formula 1 above, and

B is selected from the group consisting of hydroxyl, amine, halogen, thiol, sulfonyl chloride, and carboxylate, and is preferably hydroxyl or amine. The preferred conditions for the reaction are at a temperature of from about 0° C. and about 60° C. Suitable solvents include tetrahydrofuran, methyl isobutyl ketone, acetone or ethyl acetate. A tertiary amine is used as a base to scavange any acid chloride formed during the reaction.

The compound of Formula 3 is prepared by the dipolar cycloaddition reaction between a perfluorinated alkyl alkyl azide with an aliphatic or aromatic alkyne in the presence of copper metal as a catalyst. The alkyne can be substituted with at least one alcohol and/or amino group, or combinations thereof. The reaction is conducted at a temperature of from about 25° C. to about 100° C. Preferably no solvent is employed, but suitable solvents include tetrahydrofuran, methyl isobutyl ketone, acetone, iospropanol, ethanol, methanol or water.

The triazole-containing fluorinated acrylic monomer of Formula 2 of the present invention is then polymerized with fluorinated (meth) acrylate or nonfluorinated (meth)acrylate to prepare the copolymer of Formula 1.

The nonfluorinated (meth)acrylate monomers suitable for use in the preparation of the copolymer of Formula 1 of the present invention comprise alkyl (meth)acrylates in which the alkyl group is a straight or branched chain containing 1 to 20 carbon atoms, or mixtures thereof, preferably 8 to 18 carbon atoms. The C₂-C₂₀ alkyl (meth)acrylates (linear or branched) are exemplified by, but not limited to, alkyl(meth)acrylates where the alkyl group is methyl, ethyl, propyl, butyl, isoamyl, hexyl, cyclohexyl, octyl, 2-ethylhexyl, decyl, isodecyl, lauryl, cetyl, or stearyl. The preferred examples are 2-ethylhexyl acrylate, lauryl acrylate and stearyl acrylate.

Additional optional monomers can also be used in the polymerization reaction to prepare the copolymers of Formula 1 containing additional repeating units. These optional monomers include N-methylol (meth)acrylates, hydroxyalkyl (meth)acrylates, alkyloxy(meth)acrylates, fluorinated (meth)acrylates, glycidyl (meth)acrylates, stearyl acrylate, aminoalkyl methacrylate hydrochloride, acrylamide, alkyl acrylamide, vinyl acetate, vinyl stearate, alkyl vinyl sulfone, styrene, vinyl benzoic acid, alkyl vinyl ether, maleic anhydride, vinylidene chloride, vinyl chloride, and olefin.

Optional N-methylol monomers are exemplified by, but not limited to N-methylolacrylamide and N-methylolmethacrylamide. The optional hydroxyalkyl (meth)acrylates have alkyl chain lengths in range between 2 and 4 carbon atoms, and are exemplified by 2-hydroxyethyl acrylate, 2-hydroxyethyl methacrylate. The optional alkyloxy(meth)acrylates also have alkyl chain lengths in range between 2 and 4 carbon atoms, and contain between 1 and 12 oxyalkylene units per molecule, preferably between 4 and 10 oxyalkylene units per molecule, and most preferably between 6 and 8 oxyalkylene units per molecule, as determined by gas chromatography/mass spectrometry. Specific examples of the poly(oxyalkylene)(meth)acrylates are exemplified by, but not limited to, the reaction product of 2-hydroxyethyl methacrylate ethylene oxide. The reaction with nine mols pf ethylene oxide yields 2-hydroxyethyl methacrylate/9-ethylene oxide adduct, and the reaction with six mols of ethylene oxide yields 2-hydroxyethyl methacrylate/6-ethylene oxide adduct. Other optional nonfluorinated monomers can be styrene, maleic anhydride, and vinylidene chloride. When such optional monomers are present, polymerization processes employed are conventional ones known to those skilled in the art.

The fluorinated copolymers of Formula 1 of this invention are prepared in organic solvent or water by free radical initiated polymerization of a mixture of triazole-containing fluorinated acrylic monomers of Formula 2 with a (meth)acrylate, and, any of the optional monomers listed above. The fluorinated copolymers of this invention are made by agitating the monomers described above in organic solvent or water with a surfactant in a suitable reaction vessel which is equipped with an agitation device and an external heating and cooling device. A free radical initiator is added and the temperature raised to from about 40° to about 70° C. A polymerization regulator or chain transfer agent may be added to control molecular weight of the resultant polymer. The polymerization initiator is exemplified by 2,2′-azobis(2-amidinopropane dihydrochloride or 2,2′-azobis(isobutyramidine) dihydrochloride. These initiators are sold by E. I. du Pont de Nemours and Company, Wilmington, Del., commercially under the name of “VAZO”. An example of the polymerization regulator or chain transfer agent is dodecylmercaptan. Suitable organic solvents useful in the preparation of the copolymers of Formula 1 of the present invention include tetrahydrofuran, acetone, methyl isobutyl ketone, isopropanol, ethyl acetate, and mixtures of them. Tetrahydrofuran is preferred. The reaction is conducted under an inert gas, such as nitrogen, to the exclusion of oxygen. The solvent can be removed by evaporation, or the solution can be retained for dilution and application to the substrate. The product of the reaction is a triazole-containing fluorinated copolymer of Formula 1.

The triazole-containing fluorinated copolymer of Formula 1 can be made using from about 25 to about 80 weight % triazole-containing fluorinated acrylate of Formula 2, from about 1 to about 40 weight % (meth)acrylate, and from 0 to about 75 weight % optional monomers.

The resulting triazole-containing fluorinated copolymer of Formula 1 is then diluted with water, or further dispersed or dissolved in a solvent selected from the groups comprising simple alcohols and ketones that are suitable as the solvent for final application to substrates (hereinafter the “application solvent”).

Alternatively, an aqueous dispersion, made by conventional methods with surfactants, is prepared by removing solvents by evaporation and the use of emulsification or homogenization procedures known to those skilled in the art. Such solvent-free emulsions may be preferred to minimize flammability and volatile organic compounds (VOC) concerns.

The final product for application to a substrate is a dispersion (if water based) or a solution (if solvents other than water are used) of the triazole-containing fluorinated copolymer of Formula 1.

The present invention further comprises a method of providing oil repellency, soil repellency and stain resistance to a substrate comprising contacting the triazole-containing fluorinated copolymer solutions or dispersions of Formula 1 of the present invention with the substrate. Suitable substrates include fibrous or hard surface substrates as defined below.

The present invention further comprises a method of providing water repellency and alcohol repellency to a substrate comprising contacting the substrate with triazole-containing fluorinated copolymer solutions or dispersion of Formula 1A.
[R_{f}—X₁-A-X₁—Y—C(O)—CZCH₂]ₘ—[W_{q}]ₚ Formula 1A
wherein

R_{f} is a straight or branched perfluoroalkyl group having from about 2 to about 20 carbon atoms, or a mixture thereof, which is optionally interrupted by at least one oxygen atom,

each X₁ is independently an organic divalent linking group having from about 1 to about 20 carbon atoms, optionally containing a triazole, oxygen, nitrogen, or sulfur, or a combination thereof,

A is a 1,2,3-triazole,

Y is O or N(R)₂ wherein R is H or C₁ to C₂₀ alkyl,

Z is H, a straight or branched alkyl group having from about 1 to about 4 carbon atoms, or halide,

m is a positive integer,

q is zero or a positive integer,

p is zero or a positive integer, and

W is 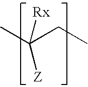
or [R¹—X₁—Y—C(O)—CH₂Z],
wherein

X₁, Y, and Z are as defined above,

Rx is C(O)O(R¹), C(O)N(R²)₂, OC(O)(R¹), SO₂(R¹), O(R¹), halide, or R¹;

each R¹ is independently H, CₙH₂ₙ₊₁, CₙH₂ₙ—CH(O)CH₂, [CH₂CH₂O]ᵢR⁴, [CₙC₂ₙ]N(R⁴)₂ or [CₙH₂ₙ]CF₂ₙ₊₁,

n is 1 to 40,

R⁴ is H,

s=0 to 40,

i=1 to 200,

each R² is independently H, or CₜH₂ₜ₊₁ wherein t is 1 to 20,

each R³ is independently H, COOR¹, halogen, N(R¹)₂, OR¹, SO₂NHR¹, CH═CH₂, or SO₃M,

M is H, alkali metal salt, alkaline earth metal salt, or ammonium.

The triazole-containing fluorinated copolymer solution or dispersion of the present invention is applied to the substrate by any suitable method. Such methods are known to those skilled in the art, and include, but are not limited to, application by exhaustion, foam, flex-nip, nip, pad, kiss-roll, beck, skein, winch, liquid injection, overflow flood, roll, brush, roller, spray, dipping, immersion, and the like. It can also be applied by use of the conventional beck dyeing procedure, continuous dyeing procedure or thread-line application.

The triazole-containing fluorinated copolymer solution or dispersion of this invention is applied to the substrate as such, or in combination with other optional textile finishes or surface treating agents.

Such optional additional components include treating agents or finishes to achieve additional surface effects, or additives commonly used with such agents or finishes. Such additional components comprise compounds or compositions that provide surface effects such as no iron, easy to iron, shrinkage control, wrinkle free, permanent press, moisture control, softness, strength, anti-slip, anti-static, anti-snag, anti-pill, stain repellency, stain release, soil repellency, soil release, water repellency, oil repellency, odor control, antimicrobial, sun protection, and similar effects. One or more such treating agents or finishes can be applied to the substrate before, after, or simultaneously with the copolymer of the present invention. For example for fibrous substrates, when synthetic or cotton fabrics are treated, use of a wetting agent can be desirable, such as ALKANOL 6112 available from E. I. du Pont de Nemours and Company, Wilmington, Del. When cotton or cotton-blended fabrics are treated, a wrinkle-resistant resin can be used such as PERMAFRESH EFC available from Omnova Solutions, Chester, S.C.

Other additives commonly used with such treating agents or finishes may also be present such as surfactants, pH adjusters, cross linkers, wetting agents, wax extenders, and other additives known by those skilled in the art. Suitable surfactants include anionic, cationic, and nonionic. Preferred is an anionic surfactant such as sodium lauryl sulfonate, available as DUPONOL WAQE from Witco Corporation, Greenwich, Conn. Examples of such finishes or agents include processing aids, foaming agents, lubricants, anti-stains, and the like. The composition is applied at a manufacturing facility, retailer location, or prior to installation and use, or at a consumer location.

Application rates for the triazole-containing fluorinated copolymer solution or dispersion of Formula 1 of the present invention are in the range of from about 10 to about 1000 g/m² depending on the substrate porosity. A treated fibrous substrate typically has a fluorine content of from about 0.05% to about 1.0% by weight.

Optionally a blocked isocyanate to further promote durability is added with the composition of Formula 1 (i.e., as a blended isocyanate). An example of a suitable blocked isocyanate to use in the present invention is HYDROPHOBOL XAN available from Ciba Specialty Chemicals, High Point, N.J. Other commercially available blocked isocyanates are also suitable for use herein. The desirability of adding a blocked isocyanate depends on the particular application for the copolymer. For most of the presently envisioned applications, it does not need to be present to achieve satisfactory cross-linking between chains or bonding to the substrate. When added as a blended isocyanate, amounts up to about 20% by weight can be added.

Optionally, nonfluorinated extender compositions are also included in the application composition to potentially further increase fluorine efficiency. Examples of such optional additional extender polymer compositions are those disclosed in co-pending U.S. Provisional Application No. 60/607,612, filed Sep. 7, 2004 (CH2996), and in U.S. Ser. No. 11/175680 filed Jul. 6, 2005 (CH3048).

The optimal repellent treatment for a given substrate depends on (1) the characteristics of the fluorinated copolymer, (2) the characteristics of the surface of the substrate, (3) the amount of fluorinated copolymer applied to the surface, (4) the method of application of the fluorinated copolymer onto the surface, and many other factors. Some fluorinated copolymer repellents work well on many different substrates and are repellent to oil, water, and a wide range of other liquids. Other fluorinated copolymer repellents exhibit superior repellency on some substrates or require higher loading levels.

The present invention also comprises substrates treated with the triazole-containing fluorinated copolymer solution or dispersion of Formula 1 of the present invention. Suitable substrates include fibrous or hard surface substrates. The fibrous substrates include woven and nonwoven fibers, fabrics, fabric blends, textiles, nonwovens, paper, leather, and carpets. These are made from natural or synthetic fibers including cotton, cellulose, wool, silk, polyamide, polyester, polyolefin, polyacrylonitrile, polypropylene, rayon, nylon, aramid, and acetate or blends thereof. By “fabric blends” is meant fabric made of two or more types of fibers. Typically these blends are a combination of at least one natural fiber and at least one synthetic fiber, but also can include a blend of two or more natural fibers or of two or more synthetic fibers. The hard surface substrates include porous and non-porous mineral surfaces, such as glass, stone, masonry, concrete, unglazed tile, brick, porous clay, and various other substrates with surface porosity. Specific examples of such substrates include unglazed concrete, brick, tile, stone (including granite and limestone), grout, mortar, marble, limestone, statuary, monuments, wood, composite materials such as terrazzo, and wall and ceiling panels including those fabricated with gypsum board. These are used in the construction of buildings, roads, parking ramps, driveways, floorings, fireplaces, fireplace hearths, counter tops, and other decorative uses in interior and exterior applications.

The triazole-containing fluorinated copolymer compositions of the present invention are useful to provide one or more of excellent water repellency, alcohol repellency, oil repellency, soil repellency, and stain resistance to treated substrates. This excellent water-, alcohol-, oil-, and soil repellency and stain resistance is obtained using lower fluorine concentrations compared with conventional perfluorocarbon surface treatment agents, providing improved “fluorine efficiency” in the protection of treated surfaces. The triazole-containing fluorinated copolymers of the present invention are effective at fluorine concentrations about one half to one third of the fluorine concentration for conventional fluorochemical surface protectants. As an example of this improved fluorine efficiency, the triazole-containing fluorinated acrylate/octadecylacrylate of the present invention having a fluorine content of 24% of the dry polymer by weight, provided equal or increased water, alcohol, and oil repellency, soil resistance and stain resistance to test substrates compared to substrates treated with a conventional surface protectant dispersion of a copolymer of perfluoroalkylethylacrylate/octadecylacrylate, having a fluorine content of 40% by weight. The triazole-containing fluorinated copolymers of the present invention also allow for the use of shorter fluoroalkyl groups containing 6 or fewer carbon atoms while conventional commercially available acrylates not containing triazole typically show poor oil repellency and water repellency performance if the fluoroalkyl groups contain less 8 carbon atoms.

### Test Methods

Test Method 1—Fabric Treatment

The fabric was treated with the copolymer dispersion or solution using a pad bath (dipping) process. A bath containing 0.2 to 2% of the fluorinated product, as detailed in the Tables in the Examples, was used to treat fabric substrates, often in combination with a blocked extender (0 to 2%) and/or a softener (0 to 2%) as specified in the tests. A wetting agent was also included in the bath at 0.2% for nylon fabrics. After application, the fabric was optionally dried and cured at approximately 160° C. for 1-3 minutes. The fabric was allowed to cool down to room temperature after treatment and cure.

Test Method 2—Laundering Procedure

The fabric samples were laundered according to the U.S. Home Laundering Method outlined in the TEFLON Global Specifications and Quality Control Tests information packet. Fabric samples were loaded into a KENMORE automatic washer with a ballast load to give a total dry load of 4 lb. (1.0 kg). A commercial detergent was added (MTCC 1993 Standard Reference Detergent WOB) and the washer was filled to a high water level with warm water (105° F.) (41° C.). The samples and ballast were washed a designated number of times (5HW=5 washes, 10HW=10 washes, etc.) using a 12-minute normal wash cycle followed by rinse and spin cycles. The samples were not dried between wash cycles. After washing was complete, the wet fabric samples and ballast were transferred to a KENMORE automatic dryer and dried for 45 minutes at the high/cotton setting to achieve a vent temperature of 155-160° F. (68-71° C.)

Test Method 3—Water Repellency

The water repellency of a treated substrate was measured according to AATCC standard Test Method No. 193-2004 and the DuPont Technical Laboratory Method as outlined in the TEFLON Global Specifications and Quality Control Tests information packet. The test determines the resistance of a treated substrate to wetting by aqueous liquids. Drops of water-alcohol mixtures of varying surface tensions are placed on the substrate and the extent of surface wetting is determined visually. The test provides a rough index of aqueous stain resistance. The higher the water repellency rating, the better the resistance of a finished substrate to staining by water-based substances.

The composition of water repellency test liquids is shown in table 1.

TABLE 1
Water Repellency Test Liquids

| Water Repellency | Composition, | Vol % |
|---|---|---|
| Rating Number | Isopropyl Alcohol | Distilled Water |
| 1 | 2 | 98 |
| 2 | 5 | 95 |
| 3 | 10 | 90 |
| 4 | 20 | 80 |
| 5 | 30 | 70 |
| 6 | 40 | 60 |
| 7 | 50 | 50 |
| 8 | 60 | 40 |
| 9 | 70 | 30 |
| 10 | 80 | 20 |
| 11 | 90 | 10 |
| 12 | 100 | 0 |

Testing Procedure:

Three drops of Test Liquid 1 are placed on the treated substrate. After 10 seconds, the drops are removed by using vacuum aspiration. If no liquid penetration or partial absorption (appearance of a darker wet patch on the substrate) is observed, the test is repeated with Test Liquid 2. The test is repeated with Test Liquid 3 and progressively higher Test Liquid numbers until liquid penetration (appearance of a darker wet patch on the substrate) is observed. The test result is the highest Test Liquid number that does not penetrate into the substrate. Higher scores indicate greater repellency.

Test Method 4—Water Repellency—Spray Rating

Water repellency can be further tested by utilizing the spray test method. The treated fabric samples were tested for water repellency by following the AATCC standard Test Method No. 22-1996, conducted as follows. A fabric sample, treated with an aqueous dispersion of polymer as previously described, is maintained for a minimum of 2 hours at 23° C.+20% relative humidity and 65° C.+10% relative humidity. The fabric sample is then securely fastened on a plastic/metal embroidery hoop such that the fabric is wrinkle-free. The hoop is placed on the testing stand so that the fabric is facing up. Then 250 mL of water at 80+-2° F. (27+-1° C.) is poured into the testing funnel allowing the water to spray onto the fabric surface. Once the water has run through the funnel, the hoop is rapped against the edge of a solid object with the fabric facing down, rotated 180 degrees and rapped again. The spotted or wetted surface is compared with the MTCC standards found in the MTCC Technical Manual. The more wet the surface, the lower the number and the poorer the repellency. A 100 denotes no wetting, a 90 denotes slight wetting (three small spots), an 80 denotes wetting signified by several (10) spots at the spray points, a 70 denotes partial wetting of the upper fabric surface, a 50 denotes wetting of the entire upper fabric surface, a 0 denotes complete wetting of the lower and upper fabric surface. A higher rating indicates greater repellency.

Test Method 5—Oil Repellency

The treated fabric samples were tested for oil repellency by a modification of AATCC standard Test Method No. 118, conducted as follows. A fabric sample, treated with an aqueous dispersion of polymer as previously described, is maintained for a minimum of 2 hours at 23° C.+20% relative humidity and 65° C.+10% relative humidity. A series of organic liquids, identified below in Table 2, are then applied dropwise to the fabric samples. Beginning with the lowest numbered test liquid (Repellency Rating No. 1), one drop (approximately 5 mm in diameter or 0.05 mL volume) is placed on each of three locations at least 5 mm apart. The drops are observed for 30 seconds. If, at the end of this period, two of the three drops are still spherical in shape with no wicking around the drops, three drops of the next highest numbered liquid are placed on adjacent sites and similarly observed for 30 seconds. The procedure is continued until one of the test liquids results in two of the three drops failing to remain spherical to hemispherical, or wetting or wicking occurs.

The oil repellency rating of the fabric is the highest numbered test liquid for which two of the three drops remained spherical to hemispherical, with no wicking for 30 seconds. In general, treated fabrics with a rating of 5 or more are considered good to excellent; fabrics having a rating of one or greater can be used in certain applications.

The treated samples of hard surface substrates were tested for oil repellency by a modification of MTCC standard Test Method No. 118, conducted as follows. Three drops of Test Oil 1 in Table 2 are placed on the treated substrate. After 30 s, the drops are removed by using vacuum aspiration. If no liquid penetration or partial absorption (appearance of a darker wet patch on the substrate) is observed, the test is repeated with Test Oil 2. The test is repeated with Test Oil 3 and progressively higher Test Oil numbers until liquid penetration (appearance of a darker wet patch on the substrate) is observed. The test result is the highest Test Oil number that does not show liquid penetration into the substrate.

TABLE 2
Oil Repellency Test Liquids

| Oil Repellency | |
|---|---|
| Rating Number | Test Solution |
| 1 | NUJOL Purified Mineral Oil |
| 2 | 65/35 NUJOL/n-hexadecane by volume at 21° C. |
| 3 | n-hexadecane |
| 4 | n-tetradecane |
| 5 | n-dodecane |
| 6 | n-decane |
| 7 | n-octane |
| 8 | n-heptane |

Note:
NUJOL is a trademark of Plough, Inc., for a mineral oil having a Saybolt viscosity of 360/390 at 38° C. and a specific gravity of 0.880/0.900 at 15° C.

Test Method 6—Stain Test

Stain testing was conducted on the indicated samples using the following procedure. Samples of treated and untreated (control) substrate are prepared and dried for 16 to 48 h at room temperature. Droplets of selected commercially available products are used to stain the substrates. Stains are applied to the treated surface and allowed to stay in contact with the substrate for 24 h at room temperature. The stains and sources are shown in Table 3.

A scrubbing brush is passed 50 times (50 strokes) over the substrate, using a pressure of 0.6 N/cm². The substrate is rinsed with tap water and then deionized water before the stain is evaluated. The surface where the stain droplets were applied is rated according to the following criteria shown in Table 4. A lower number indicates greater stain resistance.

TABLE 3
Stains

| Stain | Manufacturer |
|---|---|
| Coffee (black) | FOLGERS, Proctor and Gamble |
| Pfeiffer Salad Dressing | T. Marzetti |
| Ketchup (Heinz) | Heinz |
| Cola | COCA-COLA |
| Mustard | Plochman's |
| Grape Juice (purple) | Welch's |
| Lemon Juice | Concord Foods |
| Wesson Oil (soybean) | Wesson |
| Bacon Grease | Ritchfield |

TABLE 4
Stain Scores

| Score | Description |
|---|---|
| 0 | No perceptible stain |
| 1 | Stain slightly perceptible |
| 2 | Visible stain but the outline is not defined |
| 3 | Stain clearly delimited but not very deep |
| 4 | Stain clearly delimited and very deep |

Test Method 7—Contact Angle Measurement

Contact angles were measured using the following procedure. 12 inch×12 inch (30.5 cm×30.5 cm) Walker Zanger Alhambra Limestone tiles are wiped with isopropyl alcohol (IPA) to remove any dust or dirt, and are allowed to dry thoroughly, for 2-3 hours. The tile is evenly divided into 10 sections and a strip of masking tape is used to partition the test area. Limestone tiles are twice dipped for 30 s into the application solution or dispersion to be tested, allowing a drying time of 2 min. between dips. The samples are then allowed to dry under ambient conditions for 48 hr. Three 40 microL drop of deionized water are applied onto the tiles and allowed to sit for 5 minutes at 23° C. and the contact angles are measured. A higher contact angle indicates a more repellent surface. A repellency-rating chart is used to determine contact angle using a 5 to 0 scale, with 5 being excellent and 0 representing penetration. (See the repellency-rating chart below).

| | |
|---|---|
| 5 = Contact angle 100-120° | 4 = Contact angle 75-90° |
| 3 = Contact angle 45-75° | 2 = Contact angle 25-45° |
| 1 = Contact angle 10-25 | 0 = Contact angle <10° |

Test Method 8—Dry Soil Test

The treated fabric samples were tested for the soil resistance using the following procedure. Fabric samples to be tested are cut into 10×10 cm squares, and are shaken in a paper bag with 5% of synthetic soil based on the dry weight of the fabric samples. A maximum of six samples are shaken simultaneously in the bag. The synthetic soil was prepared as described in MTCC Test Method 123-2000, Section 8. The paper bag has a size of approximately 40 cm h×20 cm w×12 cm. The bag is shaken by hand for 5 minutes. The fabric samples are removed from the paper bag, and then cleaned by vacuuming. The soiled fabric samples are placed along with an unsoiled square of the same fabric for comparison. The samples are graded compared against a control (unsoiled) fabric square to measure the color difference. The samples are rated on a scale of 1 to 5 compared to standard photographs as published in “DuPont Textiles and Interiors Global Specifications and Quality Control Tests for Fabrics Treated with TEFLON”, available from E. I. du Pont de Nemours and Company, Wilmington, Del. Higher numbers indicate superior repellency.

Test Method 9—Oil Repellency for Paper

The oil repellency of paper samples were tested by using the Tappi Kit Test Procedure (TAPPI UM 557). Each test specimen was placed on a clean flat surface, test side up, being careful not to touch the area to be tested. From a height of about one inch (2.5 cm), a drop of Tappi Kit test solution from an intermediate Kit Number testing bottle was dropped onto the test area. A stop watch was started as the drop was applied. After exactly 15 seconds, the excess fluid was removed with a clean swatch of cotton tissue and the wetted area was immediately examined. Failure was evidenced by a pronounced darkening of the specimen caused by penetration, even in a small area, under the drop. The procedure was repeated as required, making sure that drops from other Kit Number bottles fell in untouched areas. The Results were reported as the Kit Rating, which was the highest numbered solution that stood on the surface of the specimen for 15 seconds without causing failure. The average Kit Rating of five specimens to the nearest 0.5 number was reported.

The composition of Tappi Kit test solution is shown in Table 5.

TABLE 5
Tappi Kit Test Solution

| | Castor Oil | Toluene | Heptane |
|---|---|---|---|
| Rating Number | (ml) | (ml) | (ml) |
| 1 | 200 | 0 | 0 |
| 2 | 180 | 10 | 10 |
| 3 | 160 | 20 | 20 |
| 4 | 140 | 30 | 30 |
| 5 | 120 | 40 | 40 |
| 6 | 100 | 50 | 50 |
| 7 | 80 | 60 | 60 |
| 8 | 60 | 70 | 70 |
| 9 | 40 | 80 | 80 |
| 10 | 20 | 90 | 90 |
| 11 | 0 | 100 | 100 |
| 12 | 0 | 90 | 110 |

### EXAMPLES

For all Tables in the Examples section, % F indicates the percent fluorine in the application solution or dispersion unless specified otherwise.

### Example 1

In a round bottom flask, 80.0 g (0.206 moles) of 8-azido-1,1,1,2,2,3,3,4,4,5,5,6,6-tridecafluorooctane, 0.5 g of copper turnings and 11.5 g (0.206 moles) of propargyl alcohol were charged. The mixture was stirred vigorously overnight at room temperature using a magnetic stirrer plate and a stirrer bar. The completion of the reaction was evidenced by the transformation of the liquid mixture into a white solid mass. The solid mass was dissolved in 100 mL of methanol and then filtered to remove the copper metal. Then the methanol solution was filtered through silica gel to remove any soluble copper salts from the product. The solvent was evaporated using a rotary evaporator and a white powder was obtained in 86% yield. The product of the reaction was (1-(3,3,4,4,5,5,6,6,7,7,8,8,8-tridecafluorooctyl)-1H-1,2,3-triazol-4-yl)methanol.

### Example 2

In a four-necked round bottom flask, 10 g (0.022 moles) of (1-(3,3,4,4,5,5,6,6,7,7,8,8,8-tridecafluorooctyl)-1 H-1,2,3-triazol-4-yl)methanol prepared according to the procedure of Example 1 and 3.4 g (0.034 moles) of triethylamine were dissolved in 25 mL of tetrahydrofuran. The solution was cooled to 0° C. using an ice bath and stirred at 250 rpms. A separate solution was prepared by dissolving 3.1 g (0.034 moles) of acryloyl chloride in 25 mL of tetrahydrofuran. This solution was added dropwise to the reactor while maintaining the temperature below 15° C. with the ice bath. After the addition of the acryloyl chloride solution was completed, the ice bath was removed and the reaction was allowed to continue for 1 hour. Then adding 50 mL of methanol and stirring the reaction mass for 30 minutes quenched the reaction. The solvent was evaporated using a rotary evaporator and the resulting solid was dissolved in ethyl acetate and extracted 5 times with 50-mL portions of water. The organic phase was dried over magnesium sulfate and then filtered. The solvent of the filtrate was evaporated under vacuum to obtain a light yellow solid in 82% yield. The resulting product was (1-(3,3,4,4,5,5,6,6,7,7,8,8,8-tridecafluorooctyl)-1H-1,2,3-triazol-4-yl)methyl acrylate.

### Example 3

The product of Example 2 was copolymerized with stearyl acrylate. In a test tube, 4.0 g of (1-(3,3,4,4,5,5,6,6,7,7,8,8,8-tridecafluorooctyl)-1H-1,2,3-triazol-4-yl)methyl acrylate (C6-TCFAM) prepared according to the procedure of Example 2, 2.6 g of stearyl acrylate, 0.04 g of dodecyl mercaptam, 0.08 g of Vazo 67 (E. I. du Pont de Nemours and Company, Wilmington, Del.) and 20 mL of tetrahydrofuran were mixed together using a magnetic stirrer bar and a stirrer plate. The test tube was capped with a rubber septum and placed in a dry ice/acetone bath. A subsurface nitrogen purge was applied to the cooled reaction mass for 2 hours. Then the nitrogen flow was stopped and the test tube placed on a heating block. The temperature was adjusted to 70° C. and the reaction mass was stirred overnight. The solvent was then evaporated under vacuum. An aqueous solution containing 2.5% surfactant (with respect to the amount of polymer) was prepared by dissolving 0.125 g of N,N-Dimethyl-n-octadecylamine (Armeen DM 18D), available from TCI America, San Diego, Calif., and 0.094 g of acetic acid in 30 mL of water. The triazole-containing fluorinated copolymer prepared according to the procedure of Example 3 was dried under vacuum and then dissolved in methyl isobutyl ketone (MIBK) to a concentration of 22% solids. An aliquot of 25 g of the triazole-containing fluorinated copolymer solution was added to the surfactant solution and was sonicated until the mixture became homogeneous. Then, the organic solvent was removed under vacuum. The mass of the final dispersion was adjusted to 30 g with distilled water to obtain a dispersion with approximately 20% solids.

### Example 4

In a round bottom flask, 176.8 g (0.455 moles) of 8-azido-1,1,1,2,2,3,3,4,4,5,5,6,6-tridecafluorooctane, 25.0 g (0.455 moles) of propargyl amine, and 1.0 g of copper turnings were stirred vigorously at ambient temperature using a magnetic stirrer bar. Completion of the reaction was signaled by the transformation of the liquid reaction mixture into a yellow solid mass. The crude product was dissolved in 100 mL of methanol and filtered through silica gel. Additional methanol was used to elute the product from the silica gel. Then, the methanol was evaporated under vacuum to give a yellow powder in 72% yield and with high purity of 84% as per GC analysis. The product obtained was (1-(3,3,4,4,5,5,6,6,7,7,8,8,8-tridecafluorooctyl)-1H-1,2,3-triazol-4-yl)methanamine.

### Example 5

In a test tube, 2.0 g of (1-(3,3,4,4,5,5,6,6,7,7,8,8,8-tridecafluorooctyl)-1H-1,2,3-triazol-4-yl)methyl acrylate (C6-TCFAM) prepared according to the procedure of Example 2, 1.0 g of stearyl methacrylate, 0.1 g of N-methylolacrylamide, 2-hydroxyethyl methacrylate, vinylidene chloride, 0.02 g of dodecyl mercaptam, 0.04 g of Vazo 67, and 10 mL of Tetrahydrofuran (THF) were mixed together using a magnetic stirrer bar. The test tube was capped with a rubber septum and placed inside an ice bath. A subsurface nitrogen purge was applied to the test tube for 2 hours. Then, nitrogen was stopped and the test tube was heated to 70° C. to initiate the polymerization reaction. The reaction was continued overnight and the consumption of the monomers monitored by gas chromatography. After the polymerization was completed the volume of the polymer solution was adjusted to 20 mL with THF (16% w/v polymer). The resulting dry polymer contained 30% w/w of fluorine.

### Example 6

In a four-neck round bottom flask, 20.0 g of (1-(3,3,4,4,5,5,6,6,7,7,8,8,8-tridecafluorooctyl)-1H-1,2,3-triazol-4-yl)methyl acrylate (C6-TCFAM) prepared according to the procedure of Example 2, 20.0 g of stearyl methacrylate, 2.0 g of vinylidene chloride, 1.0 g of 2-hydroxyethyl methacrylate, 1.0 g of poly(oxy-1,2-ethanediyl) methacrylate (BLEEMER PE-350) available from NOF America, New York, N.Y., 1.0 g of N-methylolacrylamide, 0.2 g of dodecyl mercaptam, 0.2 of Vazo 67, and 100 mL of methylisobutylketone (MIBK) were mixed together. The reactor was placed in an ice bath and a nitrogen purge was applied for 2 hours. Then, the nitrogen purge was stopped and the reactor temperature was adjusted to 70° C. The reaction was allowed to continue overnight while stirring. The volume of the resulting polymer solution was adjusted to 200 mL using MIBK (23% polymer solution).

A solution containing 2.5% surfactant (with respect to the amount of polymer) was prepared by dissolving 0.25 g of Armeen DM 18D and 0.19 g of acetic acid in 60 mL of water. An aliquot of 50 mL of the polymer with 7-EO methacrylate prepared above was added to the surfactant solution and the mixture is sonicated until it became homogeneous. The organic solvent was evaporated under vacuum and the final weight of the dispersion was adjusted to 60 g using distilled water. The resulting dispersion of C6-TCFAM based copolymers contained 17% solids.

### Example 7

312.0 g (4.81 moles) of sodium azide and 29.6 g (0.032 moles) of tetrabutylammonium bromide were dissolved in 500 mL of water to make a sodium azide solution. The sodium azide solution was transferred to a 3000-mL reactor and 1500 g of 1,1,1,2,2,3,3,4,4-nonafluoro-6-iodohexane was added in the reactor. The reaction mixture was stirred vigorously and the temperature of the reaction was adjusted to 95±5° C. The reaction was allowed to continue overnight. The reaction progress was monitored by GC to determine its completion. After all the 1,1,1,2,2,3,3,4,4-nonafluoro-6-iodohexane was consumed, the reaction mass was allowed to cool to ambient temperature, and solids were filtered and the organic phase was washed five times with 100-mL portions of water to ensure the complete removal of any residual sodium azide from the product. The product was dried over magnesium sulfate and filtered. The crude product was distilled under vacuum to obtain a clear liquid in 52% yield and purity of 99%. The product obtained was 6-azido-1,1,1,2,2,3,3,4,4-nonafluorohexane.

### Example 8

In a round bottom flask, 50.0 g (0.17 moles) of 6-azido-1,1,1,2,2,3,3,4,4-nonafluorohexane of Example 7 and 9.5 g (0.17 moles) of propargyl alcohol were mixed. To the mixture, 0.5 g of copper turnings was added to catalyze the reaction. The reaction mass was vigorously stirred using a magnetic stirrer bar. Completion of the reaction was signaled by the transformation of the liquid reaction mixture into a white solid mass. The crude product was dissolved in 50 mL of methanol and filtered through silica gel. Additional methanol was used to elute the product from the silica gel. Then, the methanol was evaporated under vacuum to give a white powder in 90% yield and with high purity (98%). The product obtained was (1-(3,3,4,4,5,5,6,6,-nonafluorohexyl)-1H-1,2,3-triazol-4-yl)methanol.

### Example 9

In a four-necked reactor, 25.0 g (0.072 moles) of (1-(3,3,4,4,5,5,6,6,6-nonafluorohexyl)-1H-1,2,3-triazol-4-yl)methanol of Example 8 and 7.7 g (0.076 moles) of triethylamine were dissolved in 30 mL of tetrahydrofuran (THF). The reactor was cooled to 5-10° C. by using an ice bath while vigorously stirring the solution. In a separate flask, 6.9 g (0.076 moles) of acryloyl chloride was dissolved in 20 mL of THF. The acryloyl chloride solution was then added dropwise to the reactor over a period of 30 minutes. After the addition was completed, the ice bath was removed and the reaction was allowed to continue for two hours. Then, the reaction mass was filtered to remove solids and the solvent was evaporated using a rotary evaporator. The final product was obtained a white solid in 72% yield (20.6 g) and with a purity of 93%. The product obtained was (1-(3,3,4,4,5,5,6,6,6-nonafluorohexyl)-1 H-1,2,3-triazol-4-yl)methyl acrylate.

### Example 10

In a test tube, 1.6 g (0.004 moles) of (1-(3,3,4,4,5,5,6,6,6-nonafluorohexyl)-1H-1,2,3-triazol-4-yl)methyl acrylate) prepared according to the procedure of Example 9, 1.3 g (0.004 moles) of stearyl acrylate, 0.02 g (0.0001 moles) of dodecyl mercaptam, 0.04 g (0.0002 moles) of Vazo 67, and 10 mL of THF were mixed together. The test tube was capped with a rubber septum, placed in a dry ice/acetone bath and purged with nitrogen for 2 hours. Then, nitrogen flow was stopped and the test tube placed in a heating block. The temperature of the heating block was adjusted to 70° C. and the reaction mass was stirred using a magnetic stirrer. The reaction was continued overnight and the disappearance of the monomers was monitored by GC analysis. The final volume of the polymer solution was adjusted to 20-mL with THF to give a solution containing about 14% w/v polymer. The resulting dry polymer contained 22.2% w/w of fluorine.

### Example 11

The triazole-containing fluorinated copolymer dispersion of Example 3 was applied to 100% cotton fabric using the process of Test Method 1. A total of 30 g/L of the triazole-containing fluorinated copolymer dispersion of Example 3 was used in the pad bath with about 5.0% fluorine. About 10 g/L blocked isocyanate was used in the pad bath. The blocked isocyanate used was Hydrophobol XAN, Ciba Specialty Chemicals, High Point, N.C. An anti-wrinkle-resin was included at 70 g/L, PERMAFRESH EFC available from Omnova Solutions, Chester, S.C. After application, the cotton fabric were cured at about 160° C. for about 3 minutes. The fabric was allowed to “rest” after treatment and cure. The cotton fabric was tested for water repellency, spray repellency, and oil repellency using Test Methods 3, 4 and 5 as described above. After laundering in accordance with Test Method 2 described above, the fabric was retested for water repellency, spray repellency, and oil repellency using the same methods. Results are in Table 6. The treated cotton fabric was also tested for the soil resistance using Test Method 8. Results are in Table 7. The treated cotton fabric was also tested for the stain resistance using Test Method 6. Results are in Table 8.

### Example 12

The triazole-containing fluorinated copolymer dispersion of Example 3 was applied to 100% nylon fabric using the process of Test Method 1. A total of 30 g/L of the triazole-containing fluorinated copolymer dispersion was used in the pad bath. About 0.5 g/L blocked isocyanate was used in the pad bath. The blocked isocyanate used was HYDROPHOBOL XAN, Ciba Specialty Chemicals, High Point, N.C. A wetting agent was also included in the bath at 2 g/L. This was ALKANOL 6112 available from E. I. du Pont de Nemours and Company, Wilmington, Del. After application, the nylon fabric was cured at about 160° C. for about 3 minutes. The fabric was allowed to “rest” after treatment and cure. The nylon fabric was tested for water repellency, spray repellency, and oil repellency using Test Methods 3, 4 and 5 as described above. Results are in Table 9. The treated nylon fabric was also tested for the stain resistance using Test Methods 6. Results are in Table 10.

### Example 13

The triazole-containing fluorinated copolymer dispersion of Example 3 was applied to limestone tiles for stain resistance. The limestone tiles were treated with 100 g/m² of the triazole-containing fluorinated copolymer dispersion. The dispersion had a fluorine content of 0.23%. Stain resistance was measured using Test Method 6. Results are in Table 11.

The triazole-containing fluorinated copolymer dispersion of Example 3 was also applied to limestone tiles for water and oil repellency measurement using the process of Test Method 5 and 7. The limestone tiles were treated with 100 g/m² of the triazole-containing fluorinated copolymer dispersion. Limestone tiles were twice dipped for 30 s into the dispersion, allowing a drying time of 2 min. between dips. The samples were then allowed to dry under ambient conditions for 48 hr. Three 40 microL drops of deionized water were applied onto the tiles and allowed to sit for 5 minutes at 23° C. and the contact angles were measured. A higher contact angle indicates a more repellent surface. The dispersion had a fluorine content of 0.23%. Results are in Table 12.

### Comparative Example A

In a test tube 4.6 g of a perfluoroacrylate monomer having the formula: F(CF₂)ₓC₂H₄OC(O)—C(H)═CH₂, wherein x=6, 8, 10, 12, 14 and 16 in the respective relative amounts of about 3%, 54%, 29%, 10%, 3% and 1%, said monomer having a weight average molecular weight of 569, 2.6 g of stearyl acrylate, 0.04 g of dodecyl mercaptam, 0.08 g of Vazo 67 (E. I. du Pont de Nemours and Company, Wilmington, Del.) and 20 mL of tetrahydrofuran were mixed together using a magnetic stirrer bar and a stirrer plate. The test tube was capped with a rubber septum and placed in a dry ice/acetone bath. A subsurface nitrogen purge was applied to the cooled reaction mass for 2 hours. Then the nitrogen flow was stopped and the test tube placed on a heating block. The temperature was adjusted to 70° C. and the reaction mass was stirred overnight. The solvent was then evaporated under vacuum. An aqueous solution containing 2.5% surfactant (with respect to the amount of polymer) was prepared by dissolving 0.125 g of N,N-Dimethyl-n-octadecylamine (Armeen DM 18D), available from TCI America, San Diego, Calif., and 0.094 g of acetic acid in 30 mL of water. The fluorinated acrylate copolymer was dried under vacuum and then dissolved in methyl isobutyl ketone (MIBK) to a concentration of 22% solids. An aliquot of 25 g of the copolymer solution was added to the surfactant solution and was sonicated until the mixture became homogeneous. Then, the organic solvent was removed under vacuum. The mass of the final dispersion was adjusted to 30 g with distilled water to obtain a dispersion with approximately 20% solids.

The resulting copolymer dispersion was applied to 100% cotton fabric using the process of Test Method 1. A total of 30 g/L of the copolymer dispersion was used in the pad bath with about 8.0% fluorine. The treated cotton fabric was tested for water repellency, spray repellency, and oil repellency using Test Methods 3, 4 and 5. After laundering in accordance with test Method 2, the fabric was retested for water repellency, spray repellency, and oil repellency. Results are in Table 6. The treated cotton fabric was also tested for soil resistance using Test Method 8. Results are in Table 7. The treated cotton fabric was also tested for the stain resistance using Test Method 6. Results are in Table 8.

The resulting copolymer dispersion was also applied to 100% nylon fabric using the process of Test Method 1. The nylon fabric was tested for water repellency, spray repellency, and oil repellency using Test Methods 3, 4, and 5. Results are in Table 9. The treated nylon fabric was also tested for stain resistance using Test Method 6. Results are in Table 10.

The resulting copolymer dispersion was also applied to limestone tiles for stain resistance measurement using the process of Test Method 6. The limestone tiles were treated with 100 g/m² of the copolymer dispersion. The dispersion had a fluorine content of 0.39%. Results are in Table 11.

The resulting copolymer dispersion was also applied to limestone tiles and tested for water and oil repellency measurement using Test Methods 5 and 7. The dispersion had a fluorine content of 0.39%. Results are in Table 12.

### Comparative Example B

In a four-neck round bottom flask, 20.0 g of the perfluoracrylate monomer having the formula: F(CF₂)ₓC₂H₄OC(O)—C(H)═CH₂, wherein x=6, 8, 10, 12, 14, and 16 in the respective relative amounts of about 3%, 54%, 29%, 10%, 3% and 1%, said monomer having a weight average molecular weight of 569, 20.0 g of stearyl methacrylate, 2.0 g of vinylidene chloride, 1.0 g of 2-hydroxyethyl methacrylate, 1.0 g of poly(oxy-1,2-ethanediyl) methacrylate (BLEEMER PE-350 available from NOF America, New York, N.Y.), 1.0 g of N-methylolacrylamide, 0.2 g of dodecyl mercaptam, 0.2 of Vazo 67, and 100 mL of methylisobutylketone (MIBK) were mixed together. The reactor was placed in an ice bath and a nitrogen purge was applied for 2 hours. Then, the nitrogen purge was stopped and the reactor temperature was adjusted to 70° C. The reaction was allowed to continue overnight while stirring. The solvent was then evaporated under vacuum.

A solution containing 2.5% surfactant (with respect to the amount of polymer) was prepared by dissolving 0.25 g of Armeen DM 18D and 0.19 g of acetic acid in 60 mL of water. An aliquot of 50 mL of the polymer prepared above was added to the surfactant solution and the mixture was sonicated until it became homogeneous. The organic solvent was evaporated under vacuum and the final weight of the dispersion was adjusted to 60 g using distilled water. The resulting dispersion of copolymers with poly(oxy-1,2-ethanediyl)methacrylate contained 12% solids.

The polymer dispersion was applied to 100% cotton fabric using the process of Test Method 1. A total of 30 g/L of copolymer dispersion was used in the pad bath with about 6.5% fluorine. The treated fabric was tested for water repellency, spray repellency, and oil repellency using Test Methods 3, 4 and 5. After laundering in accordance with Test Method 2, the fabric was retested for water repellency, spray repellency, and oil repellency. Results are in Table 14.

### Comparative Example C

To begin, ZONYL 8932 (E. I. du Pont de Nemours and Company, Wilmington, Del.) polymer dispersion was applied to 100% cotton fabric using the process of Test Method 1. A total of 30 g/L of the ZONYL 8932 was used in the pad bath. The cotton fabric was tested for water repellency, spray repellency, and oil repellency using Test Methods 3, 4 and 5. After laundering in accordance with test Method 2, the fabric was retested for water repellency, spray repellency, and oil repellency. Results are in Table 6. The treated cotton fabric also was tested for soil resistance using Test Method 8 Results are in Table 7. The treated cotton fabric was tested for the stain resistance using Test Method 6. Results are in Table 8.

The polymer dispersion was also applied to 100% nylon fabric using the process of Test Method 1. A total of 30 g/L of the polymer was used in the pad bath. The resulting dispersion was applied to 100% nylon fabric using the process of Test Method 1. The treated nylon fabric was tested for the stain resistance using Test Method 6. Results are in Table 10.

### Comparative Example D

ZONYL 7040 (E. I. du Pont de Nemours and Company, Wilmington, Del.) polymer dispersion was applied to 100% nylon fabric using the process of Test Method 1. A total of 30 g/L of the ZONYL 7040 was used in the pad bath. About 0.5 g/L blocked isocyanate was used in the pad bath. The nylon fabric was tested for water repellency, spray repellency, and oil repellency using Test Methods 3, 4 and 5. Results are in Table 9.

### Comparative Example E

ZONYL 8740, a commercially available stain resist, (E. I. du Pont de Nemours and Company, Wilmington, Del.) polymer dispersion was applied to limestone tiles for stain resistance measurement. The limestone tiles were treated with 100 g/m² of the ZONYL 8740 copolymer dispersion. The dispersion had a fluorine content of 0.42%. Stain resistance was measured using Test Method 6. Results are in Table 11.

The tiles were also tested for water repellency and oil repellency using Test Methods 3 and 5. Results are in Table 12.

TABLE 6
100% Cotton

| | Example | | |
|---|---|---|---|
| | | Comparative | Comparative |
| | Example 11 | Example A | Example C |
| % F** | 0.14% | 0.25 | 0.32 |
| Water Repellency | | | |
| Initial | 4 | 7 | 12 |
| 5 HW* | 4 | 7 | 7 |
| 10 HW | 4 | 5 | 4 |
| Spray Repellency | | | |
| Initial | 70 | 100 | 100 |
| 5 HW | 70 | 70 | 70 |
| 10 HW | 50 | 50 | 50 |
| Oil Repellency | | | |
| Initial | 5 | 4 | 6 |
| 5 HW | 3 | 4 | 3 |
| 10 HW | 3 | 3 | 3 |

*HW - stands for home washes, i.e. 5 HW means 5 home washes
**% F is fluorine in the applied dispersion.

From Table 6, it can be observed that application of the Example 11 copolymer to cotton fabrics having a shorter perfluoroalkyl chain length than Comparative Example A, and applied at about half of the fluorine content of Comparative Examples A and C provided good to excellent oil and water repellency performance. Although the initial water repellency provided by Example 11 was not as good as for Comparative Examples A and C containing higher levels of fluorine, the durability of the repellency was sustained while that of Comparative Examples A and C was not sustained. Thus over time the water repellency was comparable. However, even at the lower fluorine content of Example 11, the oil repellency values for Example 11 were comparable to that of Comparative Examples A and C.

TABLE 7
100% Cotton

| | Example | | |
|---|---|---|---|
| | | Comparative | Comparative |
| | Example 11 | Example A | Example C |
| % F* | 0.14 | 0.25 | 0.32 |
| Soil Repellency | 2 | 3 | 2 |

*% F is the fluorine in the applied dispersion.

Table 7 shows that the soil repellency performance of Example 11 having a shorter perfluoroalkyl chain length than Comparative Example A was comparative to that from Comparative Examples A and C while using about 50% less fluorine content on the substrate.

TABLE 8
100% Cotton

| | Example | | |
|---|---|---|---|
| | | Comparative | Comparative |
| | Example 11 | Example A | Example C |
| % F* | 0.14 | 0.25 | 0.32 |
| Hot Coffee | 1 | 1 | 1 |
| Corn Oil | 3 | 2 | 3 |

*% F is the fluorine in the applied dispersion.

The stain repellency properties of Example 11 having a shorter perfluoroalkyl chain length than Comparative Example A were similar to that of Comparative Examples A and C while the fluorine content was much lower. Interestingly, Example 11 was as good as Comparative Example C repelling coffee and corn oil stains while using less than 50% of the total fluorine.

TABLE 9
100% Nylon

| | Example | | |
|---|---|---|---|
| | | Comparative | Comparative |
| | Example 12 | Example A | Example D |
| % F** | 0.14 | 0.25 | 0.20 |
| Water Repellency | | | |
| Initial | 8 | 8 | 10 |
| 5 HW* | 4 | 5 | 7 |
| 10 HW | 4 | 4 | 5 |
| Spray Repellency | | | |
| Initial | 80 | 90 | 100 |
| 5 HW | 70 | 70 | 100 |
| 10 HW | 50 | 50 | 90 |
| Oil Repellency | | | |
| Initial | 5 | 2 | 5 |
| 5 HW | 2 | 2 | 3 |
| 10 HW | 1 | 1 | 2 |

*HW - stands for home washes, i.e. 5 HW means 5 home washes
**% F is the fluorine in the applied dispersion.

Application of Example 12 copolymer to nylon fabrics, at about half of the fluorine content of Comparative Examples A and D, provided excellent oil and water repellency performance. In this case both the water and oil repellency provided by Example 12 was as good or better than for Comparative Examples A and D. It is also evident that oil repellency was the best attribute of Example 12 when compared to the Comparative Example A and D products.

TABLE 10
100% Nylon

| | Example | | |
|---|---|---|---|
| | | Comparative | Comparative |
| | Example 12 | Example A | Example C |
| % F* | 0.14 | 0.25 | 0.32 |
| Hot Coffee | 1 | 1 | 1 |
| Corn Oil | 2 | 2 | 2 |

*% F is the fluorine in the applied dispersion.

The stain repellency properties of Example 12 were equivalent to that of Comparative Examples A and C while the fluorine content was much lower. Example 12 was as good as Comparative Example C repelling coffee and corn oil stains while using less than 50% of the total fluorine.

TABLE 11
Stain Resistance on Limestone Tiles

Example

| | | Comparative |
|---|---|---|
| | Example 13 | Example A |
| gF/m²* | 0.29 | 0.40 |
| Coffee (black) | 4 | 4 |
| Pfeiffer Salad | 4 | 4 |
| Dressing | | |
| Ketchup (Heinz) | 1 | 2 |
| Coke | 2 | 3 |
| Mustard | 1 | 3 |
| Grape Juice | 3 | 4 |
| (purple) | | |
| Lemon Juice | 3 | 3 |
| Wesson Oil | 4 | 4 |
| (soybean) | | |
| Bacon Grease | 4 | 4 |
| Total | 26 | 31 |

*gF/m² is amount of fluorine on substrate surface.

The Example 13 copolymer showed comparable stain resistance on limestone tiles when compared with Comparative Examples A having a longer fluoroalkyl chain length. This performance was obtained with only 0.29 gF/m² of fluorine on the substrate for Example 13 compared to 0.40 gF/m² on the substrate for Comparative Example A demonstrating that the incorporation of the triazole group into this type of polymer improved fluorine efficiency.

TABLE 12
Limestone Tiles

| | Example | | |
|---|---|---|---|
| | | Comparative | Comparative |
| | Example 13 | Example A | Example D |
| % F* | 0.29 | 0.40 | 0.41 |
| Water Repellency | 5 | 5 | 4 |
| Oil Repellency | 1 | 0 | 2 |

*% F is the fluorine in the applied dispersion.

The overall performance of Example 13 for water and oil repellency on the treated substrate was comparable or better than for the Comparative Examples A and E materials. This example demonstrated again the improved fluorine efficiency of the copolymer of the present invention.

### Example 14

The copolymer solution prepared according to the procedure of Example 5 was applied to 100% cotton fabric and 100% nylon fabric using a modified process of Test Method 1. The fabric samples were cut into square pieces of 2 inches by 2 inches (5.1 cm by 5.1 cm). The copolymer prepared according to the procedure of Example 5 was applied to the fabric using a dropper. The number of drops added and the weight of polymer added were measured. 0.148 gram of the copolymer was added to the cotton fabric, and 0.071 gram of the copolymer was added to nylon fabric, with 4.8% fluorine and 5.5% fluorine content respectively. After application, the fabric was allowed to air dry for at least two hours and cured at about 150° C. for about 3 minutes. The fabric was allowed to “rest” after treatment and cure. The fabrics were tested for water repellency and oil repellency using Test Methods 3 and 5 as described above. Results are in Table 13.

TABLE 13

Treated Fabric

| | Cotton | Nylon |
|---|---|---|
| % F* | 4.8% | 5.5% |
| Water Repellency | 10 | 7 |
| Oil Repellency | 6 | 6 |

*% F is the amount of fluorine on the fabric.

The Example 14 copolymers contained units derived from optional monomers, vinylidene chloride, N-methylolacrylamide and 2-hydroxyethyl methacrylate and demonstrated excellent oil and water repellency performance.

### Example 15

A polymer dispersion of the triazole-containing fluorinated copolymer prepared according to the procedure of Example 6 was applied to 100% cotton fabric using the process of Test Method 1. A total of 30 g/L of the triazole-containing fluorinated copolymer dispersion was used in the pad bath. About 10 g/L blocked isocyanate was used in the pad bath. The blocked isocyanate used was Hydrophobol XAN, Ciba Specialty Chemicals, High Point, N.C. An anti-wrinkle- resin was included at 70 g/L, PERMAFRESH EFC available from Omnova Solutions, Chester, S.C. After application, the cotton fabric were cured at about 160° C. for about 3 minutes. The fabric was allowed to “rest” after treatment and cure. The cotton fabric was tested for water repellency, spray repellency, and oil repellency using Test Methods 3, 4 and 5 as described above. After laundering in accordance with Test Method 2, the fabric was retested for water repellency, spray repellency, and oil repellency using the same methods. Results are in Table 14.

Comparative Example C, as previously described, was also applied to 100% cotton fabric using the same process as above for Example 15. A total of 30 g/L of copolymer dispersion of Comparative Example C was used in the pad bath. The treated fabric was tested, laundered, and retested as for Example 15. Results are in Table 14.

TABLE 14

| | | Comparative | Comparative |
|---|---|---|---|
| | Example 15 | Example B | Example C |
| % F** | 0.7 | 0.8 | 1.3 |
| Water | | | |
| Repellency | | | |
| Initial | 4 | 4 | 6 |
| 5 HW | 4 | 3 | 6.5 |
| 10 HW | 3.5 | 3 | 4 |
| Spray | | | |
| Repellency | | | |
| Initial | 70 | 80 | 100 |
| 5 HW*** | 70 | 70 | 70 |
| 10 HW | 60 | 50/0* | 60 |
| Oil Repellency | | | |
| Initial | 2 | 0 | 6 |
| 5 HW | 1 | 0 | 4 |
| 10 HW | 0.5 | 0 | 1.5 |

*50/0 - surface of the fabric wasn't completely wet, but water penetrated to the back surface of the fabric.
**% F is the fluorine in the applied dispersion.
***HW - stands for home washes, i.e. 5HW means 5 home washes

The results on Table 14 demonstrate that Example 15 and Comparative Example B had similar water repellency performance. However, the Example 15 formulation provided better oil repellency on the cotton fabrics while using less fluorine content. Example 15 had poorer performance than Comparative Example C when applied at a lower fluorine level.

### Example 16

The C4-triazole-containing fluorinated copolymer prepared according to the procedure of Example 10 was applied to 100% cotton fabric and 100% nylon fabric using the modified process of Test Method 1. The fabric samples were cut into square pieces of 2 inches by 2 inches (5.1 cm by 5.1 cm). The copolymer prepared according to the procedure of Example 10 was applied to the fabric using a dropper. The number of drops added and the weight of polymer added were measured. 0.021 gram of the copolymer was added to the cotton fabric, and 0.040 gram of the copolymer was added to nylon fabric, with 0.7% fluorine and 2.2% fluorine content respectively. After application, the fabric was allowed to air dry for at least two hours and cured at about 150° C. for about 3 minutes. The fabric was allowed to “rest” after treatment and cure. The fabrics were tested for water repellency and oil repellency using Test Methods 3 and 5 as described above. Results are in Table 15.

TABLE 15

Treated Fabric

| | Cotton | Nylon |
|---|---|---|
| % F* | 0.7% | 2.2% |
| Water Repellency | 5 | 6 |
| Oil Repellency | 3 | 3 |

*% F is the percent fluorine on the treated fabric.

The results shown on Table 15 indicate that triazole-containing polymers prepared with shorter telomer chains (four perfluorinated carbons) provided oil and water repellency on both cotton and nylon.

### Examples 17-39

For each Example from Example 17 to from Example 39, the product of Example 2 was copolymerized with Monomer B or mixtures of Monomers B as listed below in Table 16. In a test tube, the amount listed in Table 16 of (1-(3,3,4,4,5,5,6,6,7,7,8,8,8-tridecafluorooctyl)-1H-1,2,3-triazol-4-yl)methyl acrylate prepared according to the procedure of Example 2, the amount listed in Table 16 of Monomer B, 0.03 g of dodecyl mercaptam, 0.1 g of VAZO 67 (E.I. du Pont de Nemours and Company, Wilmington, Del.) and 45 mL of tetrahydrofuran (THF) were mixed together using a magnetic stirrer bar and a stirrer plate. The test tube was capped with a rubber septum and placed in a dry ice/acetone bath. A subsurface nitrogen purge was applied to the cooled reaction mass for 1 hour. Then the nitrogen flow was stopped and the test tube placed on a heating block. The temperature was adjusted to 65° C. and the reaction mass was stirred for 12 hours. The resulting polymer solution was allowed to cool to the room temperature.

For Example 38 and 39, due to the low boiling point of vinyl chloride, these two reactions were run in a sealed autoclave at 70° C. for 7 hours. Both reaction mixtures also contained: 0.09 g of dodecyl mercaptan and 0.30 g VAZO 67 in a total of 300 mL THF with nitrogen purge during polymerization.

TABLE 16
Monomers in Copolymerization

| | Product of Example | Monomer(s) B | |
|---|---|---|---|
| Example | 2 (gram) | Name | (gram) |
| Example 17 | 2.50 | stearyl acrylate | 1.63 |
| Example 18 | 2.50 | stearyl acrylate | 0.33 |
| Example 19 | 2.50 | stearyl acrylate | 0.16 |
| Example 20 | 2.50 | glycidyl | 0.71 |
| | | methacrylate | |
| Example 21 | 2.50 | glycerol | 0.80 |
| | | monomethacrylate | |
| Example 22 | 2.50 | Acrylamide | 0.36 |
| Example 23 | 2.50 | dimethyl acrylamide | 0.50 |
| Example 24 | 1.25 | stearyl acrylate | 1.60 |
| | | ZONYL TA-N* | 1.41 |
| Example 25 | 1.25 | stearyl acrylate | 1.60 |
| | | ZONYL TM* | 1.31 |
| Example 26 | 2.50 | 2-Aminoethyl | 0.83 |
| | | methacrylate | |
| | | hydrochloride | |
| Example 27 | 2.50 | vinyl acetate | 0.43 |
| Example 28 | 2.50 | vinyl stearate | 1.48 |
| Example 29 | 2.50 | vinyl sulfone | 0.59 |
| Example 30 | 2.50 | 4-vinyl benzoic acid | 0.74 |
| Example 31 | 2.50 | Styrene | 0.52 |
| Example 32 | 0.50 | maleic anhydride | 0.20 |
| | | Styrene | 0.21 |
| Example 33 | 0.50 | maleic anhydride | 0.20 |
| | | octane | 0.22 |
| Example 34 | 2.50 | ethyl vinyl ether | 0.36 |
| Example 35 | 2.50 | stearyl acrylate | 1.30 |
| | | glycidyl | 0.14 |
| | | methacrylate | |
| Example 36 | 2.50 | stearyl acrylate | 1.30 |
| | | Acrylamide | 0.071 |
| Example 37 | 2.50 | stearyl acrylate | 1.30 |
| | | 2-Aminoethyl | 0.19 |
| | | methacrylate | |
| | | hydrochloride | |
| Example 38 | 7.50 | vinyl chloride | 1.89 |
| Example 39 | 7.50 | vinyl chloride | 0.48 |

*ZONYL TA-N and ZONYL TM are available from E.I. du Pont de Nemours and Company, Wilmington, Delaware.

The products from the above preparation were each applied to various fabrics described below from THF solution with final loading of about 3000 micrograms per gram fluorine by weight. The cotton fabric used in the test was a woven cotton fabric, dyed but not finished manufactured by Avondale Mills (Warrenville, S.C.) with a fabric weight of 210 grams/square meter. The nylon fabric used in the test was a woven nylon fabric, dyed but not finished manufactured by Avondale Mills (Warrenville, S.C.) with a fabric weight of 76 grams/square meter. The nonwoven fabric used in the test was a SMS PP nonwoven spunbonded-melt blown-spunbonded polypropylene fabric manufactured by Kimberly-Clark (Roswell, Ga.) with a fabric weight of 39 grams/square meter. The treated fabrics were tested for water repellency and oil repellency using Test Methods 3 and 5. The results are in Table 17.

TABLE 17
Cotton, Nylon and Nonwoven

| | Water Repellency | | | Oil Repellency | |
|---|---|---|---|---|---|
| Example | Cotton | Nylon | Nonwoven | Cotton | Nylon |
| 17 | 8 | 7 | 8 | 4 | 2 |
| 18 | 7 | 7 | 8 | 5 | 4 |
| 19 | 7 | 7 | 7 | 6 | 4 |
| 21 | 7 | 3 | 2 | 6 | 6 |
| 22 | 7 | 5 | 5 | 6 | 6 |
| 23 | 5 | 0 | 0 | 6 | 6 |
| 24 | 7 | 6 | 8 | 4 | 3 |
| 25 | 6 | 4 | 7 | 3 | 2 |
| 27 | 4 | 4 | 7 | 6 | 5 |
| 28 | 4 | 4 | 7 | 6 | 5 |
| 29 | 3 | 3 | 6 | 6 | 6 |
| 30 | 3 | 3 | 5 | 5 | 4 |
| 31 | 3 | 3 | 0 | 5 | 5 |
| 32 | 0 | 0 | 0 | 2 | 4 |
| 33 | 1 | 0 | 0 | 3 | 4 |
| 34 | 4 | 4 | 4 | 6 | 5 |
| 35 | 4 | 5 | 5 | 4 | 2 |
| 36 | 5 | 4 | 6 | 4 | 2 |
| 37 | 4 | 4 | 8 | 5 | 5 |
| 38 | 6 | 6 | 6 | 6 | 7 |
| 39 | 5 | 6 | 5 | 6 | 6 |
| Untreated | 0 | 0 | 4 | 0 | 0 |

All cotton fabrics treated with the copolymers prepared above in Examples 17-37 at a loading level of about 3000 micrograms per gram fluorine by weight gave good to excellent water repellency compared to an untreated cotton fabric except the Example 32 and 33 copolymers containing maleic anhydride.

All nylon fabrics treated with the copolymers prepared above in Examples 17-37 at a loading level of about 3000 micrograms per gram fluorine by weight gave good to excellent water repellency compared to an untreated nylon fabric except the Example 32 and 33 copolymers containing maleic anhydride and the Example 23 copolymer containing dimethyl acrylamide.

All SMS PP nonwoven fabrics treated with the copolymers prepared above in Examples 17-37 at a loading level of about 3000 micrograms per gram fluorine by weight gave good to excellent water repellency compared to an untreated SMS PP nonwoven fabric except the Example 32 and 33 copolymers containing maleic anhydride, the Example 31 copolymer containing styrene, and the Example 23 copolymer containing dimethyl acrylamide.

All cotton or nylon fabrics treated with the copolymers prepared above in Examples 17-37 at a loading level of about 3000 micrograms per gram fluorine by weight gave good to excellent oil repellency compared to an untreated cotton or nylon fabrics.

The products from the above preparation of Examples 18, 22, 28, 30 and 34 were applied to leather from THF solution at about 0.006 grams of the polymer per 100 cm². The leather used in the test was a tanned and dyed swine hide manufactured by Sheen Leather (Monrovia, Calif.). The treated leather was tested for water repellency and oil repellency using Test Methods 3 and 5. The results are in Table 18.

TABLE 18
Leather

| Example | Water Repellency | Oil Repellency |
|---|---|---|
| 18 | 4 | 1 |
| 22 | 3 | 3 |
| 28 | 3 | 2 |
| 30 | 4 | 2 |
| 34 | 4 | 2 |
| Untreated leather | 1 | 0 |

All leather samples treated with the copolymers of Examples 18, 22, 28, 30 and 34 provided both good oil repellency and water repellency compared to an untreated leather sample.

### Example 40 and Comparative Example F

In a nitrogen purged, mechanically stirred 1 L jacketed reaction vessel equipped with a condenser, thermocouple, and bottom TEFLON valve outlet the product of Example 2 (46 g, 0.092 mol) was dissolved in a twenty weight percent solution (55 g total) of isopropyl alcohol (IPA) in methyl isobutyl ketone (MIBK). After complete dissolution, dimethyl aminomethacrylate (8.6 g, 0.046 mol), glycidyl methacrylate (1.4 g, 0.010 mol), 1-dodecanethiol (0.10 g, 4.9×10⁻⁴ mol), and sodium chloride (0.12 g, 2.0×10⁻³ mol) were added while stirring at 250 rpm. A solution of the initiator, VAZO 64 (available from E. I. du Pont de Nemours and Company, Wilmington, Del.) (0.42 g, 2.0×10⁻³) in IPA (10 g), was added and the solution was subsurface sparged (1 hr) and polymerized at 80° C. for 16 hours. After polymerization was complete the reaction mass was dropped, through the bottom outlet, over 10 minutes into a room temperature (24° C.) solution of water (230 g), glacial acetic acid (2.9 g, 0.048 mol), and hydrogen peroxide (2.5 g, 0.073 mol). The solution was allowed to neutralize over 30 minutes followed by the distillation of the remaining MIBK/IPA. The resulting product was applied to paper samples for oil repellency test using the process of Test Method 9. The paper used in the test was white paper (bleached 50# paper). Results are in Table 19.

### Comparative Example F

ZONYL 9464 solution, available from E. I. du Pont de Nemours and Company, Wilmington, Del., was applied on paper samples and tested for oil repellency using the same process of Test Method 9. Results are in Table 18.

TABLE 19
Oil Repellency on Paper

| Polymer, | | | Comparative |
|---|---|---|---|
| gram/cm² | Untreated | Example 40 | Example F |
| 0 | 0 | — | — |
| 0.15 | — | 6 | 7 |
| 0.076 | — | 3 | 4 |

The data in Table 19 demonstrates that Example 40 provided excellent oil repellency when applied to a paper substrate.

What is claimed is:

1. A composition comprising a copolymer having repeating units in any sequence of Formula 1
[R_{f}—X₁-A-X₁—Y—C(O)—CZCH₂]ₘ—[W_{q}]ₚ Formula 1
wherein
R_{f} is a straight or branched perfluoroalkyl group having from about 2 to about 20 carbon atoms, or a mixture thereof, which is optionally interrupted by at least one oxygen atom,
each X₁ is independently an organic divalent linking group having from about 1 to about 20 carbon atoms, optionally containing a triazole, oxygen, nitrogen, or sulfur, or a combination thereof,
A is a 1,2,3-triazole,
Y is O or N(R)₂ wherein R is H or C₁ to C₂₀ alkyl,
Z is H, a straight or branched alkyl group having from about 1 to about 4 carbon atoms, or halide,
m is a positive integer,
q is zero or a positive integer,
p is zero or a positive integer, and
W is 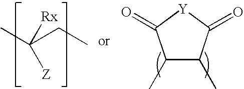
or [R¹—X₁—Y—C(O)—CH₂Z],
wherein
X₁, Y, and Z are as defined above,
Rx is C(O)O(R¹), C(O)N(R²)₂, OC(O)(R¹), SO₂(R¹), C₆(R³)₅, O(R¹), halide, or R¹;
each R¹ is independently H, CₙH₂ₙ₊₁, CₙH₂ₙ—CH(O)CH₂, [CH₂CH₂O]ᵢR⁴, [CₙC₂ₙ]N(R⁴)₂ or [CₙH₂ₙ]CₙF₂ₙ₊₁,
n is 1 to 40,
R⁴ is H or CₛH₂ₛ₊₁,
s=0 to 40,
i=1 to 200,
each R² is independently H, or CₜH₂ₜ₊₁ wherein t is 1 to 20,
each R³ is independently H, COOR¹, halogen, N(R¹)₂, OR¹, SO₂NHR¹, CH═CH₂, or SO₃M,
M is H, alkali metal salt, alkaline earth metal salt, or ammonium.

2. A composition comprising Formula 2
R_{f}—X₁-A-X₁—Y—C(O)C(Z)═CH₂
wherein
R_{f} is a straight or branched perfluoroalkyl group having from about 2 to about 20 carbon atoms, or a mixture thereof, which is optionally interrupted by at least one oxygen atom,
each X₁ is independently an organic divalent linking group having from about 1 to about 20 carbon atoms, optionally containing a triazole, oxygen, nitrogen, or sulfur, or a combination thereof,
A is a 1,2,3-triazole,
Y is O or N(R)₂ wherein R is H or C₁ to C₄ alkyl, and
Z is H or a straight or branched alkyl group having from about 1 to about 4 carbon atoms.

3. A composition comprising Formula 3
R_{f}—X₁—A-X₁—B
wherein
R_{f} is a straight or branched perfluoroalkyl group having from about 2 to about 20 carbon atoms, or a mixture thereof, which is optionally interrupted by at least one oxygen atom,
each X₁ is independently an organic divalent linking group having from about 1 to about 20 carbon atoms, optionally containing a triazole, oxygen, nitrogen, or sulfur, or a combination thereof,
A is triazole, and
B is selected from the group consisting of hydroxyl, amine, halogen, thiol, sulfonyl chloride and carboxylate.

4. The composition of claim 1, 2 or 3 wherein R_{f} is a perfluoroalkyl radical having the formula F(CF₂CF₂)ₙ, wherein n is 1 to about 10, or mixtures thereof.

5. The composition of claim 1, 2 or 3 wherein X₁ is selected from the group consisting of a straight chain, branched chain or cyclic alkylene, phenyl, arylene, aralkylene, sulfonyl, sulfoxy, sulfonamido, carbonamido, carbonyloxy, urethanylene, ureylene, and combinations thereof.

6. The composition of claim 1 wherein W is 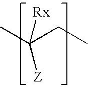
and Rₓ is C(O)O(R¹), C(O)N(R²)₂, C₆(R³)₅, or halide.

7. The composition of claim 1 in the form of an aqueous dispersion or solution.

8. The composition of claim 1 further comprising at least one of
A) an agent which provides a surface effect which is no iron, easy to iron, shrinkage control, wrinkle free, permanent press, moisture control, softness, strength, anti-slip, antistatic, anti-snag, anti-pill, stain repellency, stain release, soil repellency, soil release, water repellency, oil repellency, odor control, antimicrobial, or sun protection,
B) B) a surfactant, antioxidant, light fastness agent, color fastness agent, water, pH adjuster, cross linker, wetting agent, extender, foaming agent, processing aid, lubricant, blocked isocyanate, nonfluorinated and extenders, or
C) combinations thereof

9. The composition of claim 1 further comprising repeating units from optional monomers, said monomers selected from the group consisting of N-methylol (meth)acrylates, hydroxyalkyl (meth)acrylates, alkyloxy(meth)acrylates, fluorinated (meth)acrylates, glycidyl (meth)acrylates, stearyl acrylate, aminoalkyl methacrylate hydrochloride, acrylamide, alkyl acrylamide, vinyl acetate, vinyl stearate, alkyl vinyl sulfone, styrene, vinyl benzoic acid, alkyl vinyl ether, maleic anhydride, vinylidene chloride, vinyl chloride, and olefin.

10. The composition prepared by contacting the composition of claim 2 with fluorinated (meth)acrylate or nonfluorinated (meth)acrylate, and optional monomers.

11. The composition of claim 10 wherein the nonfluorinated (meth)acrylate comprises alkyl (meth)acrylates in which the alkyl group is a straight or branched chain containing 1 to about 20 carbon atoms.

12. The composition of claim 11 wherein the alkyl (meth)acrylates contain an alkyl group which is methyl, ethyl, propyl, butyl, isoamyl, hexyl, cyclohexyl, octyl, 2-ethylhexyl, decyl, isodecyl, lauryl, cetyl, or stearyl, preferably 2-ethylhexyl acrylate, lauryl acrylate and stearyl acrylate.

13. A method of providing oil repellency, soil repellency and stain resistance to substrates comprising contacting said substrate with a composition of Formula 1
[R_{f}—X₁-A-X₁—Y—C(O)—CZCH₂]ₘ—[W_{q}]ₚ Formula 1
wherein
R_{f} is a straight or branched perfluoroalkyl group having from about 2 to about 20 carbon atoms, or a mixture thereof, which is optionally interrupted by at least one oxygen atom,
each X₁ is independently an organic divalent linking group having from about 1 to about 20 carbon atoms, optionally containing a triazole, oxygen, nitrogen, or sulfur, or a combination thereof,
A is a 1,2,3-triazole,
Y is O or N(R)₂ wherein R is H or C₁ to C₂₀ alkyl,
Z is H, a straight or branched alkyl group having from about 1 to about 4 carbon atoms, or halide,
m is a positive integer,
q is zero or a positive integer,
p is zero or a positive integer, and
W is 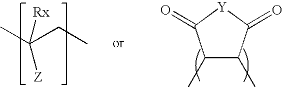
or [R¹—-X₁—Y—C(O)—CH₂Z],
wherein
X₁, Y, and Z are as defined above,
Rx is C(O)O(R¹), C(O)N(R²)₂, OC(O)(R¹), SO₂(R¹), C₆(R³)₅, O(R¹), halide, or R¹;
each R¹ is independently H, CₙH₂ₙ₊₁, CₙH₂ₙ—CH(O)CH₂, [CH₂CH₂O]ᵢR⁴, [CₙC₂ₙ]N(R⁴)₂ or [CₙH₂ₙ]CₙF₂ₙ₊₁,
n is 1 to 40,
R⁴ is H or CₛH₂ₛ₊₁,
s=0 to 40,
i=1 to 200,
each R² is independently H, or CₜH₂ₜ₊₁ wherein t is 1 to 20,
each R³ is independently H, COOR¹, halogen, N(R¹)₂, OR¹, SO₂NHR¹, CH═CH₂, or SO₃M,
M is H, alkali metal salt, alkaline earth metal salt, or ammonium.

14. A method of providing water repellency and alcohol repellency to substrates comprising contacting said substrate with a composition of Formula 1A.
[R_{f}—X₁-A-X₁—Y—C(O)—CZCH₂]ₘ—[W_{q}]ₚ Formula 1A
wherein
R_{f} is a straight or branched perfluoroalkyl group having from about 2 to about 20 carbon atoms, or a mixture thereof, which is optionally interrupted by at least one oxygen atom,
each X₁ is independently an organic divalent linking group having from about 1 to about 20 carbon atoms, optionally containing a triazole, oxygen, nitrogen, or sulfur, or a combination thereof,
A is a 1,2,3-triazole,
Y is O or N(R)₂ wherein R is H or C₁ to C₂₀ alkyl,
Z is H, a straight or branched alkyl group having from about 1 to about 4 carbon atoms, or halide,
m is a positive integer,
q is zero or a positive integer,
p is zero or a positive integer, and
W is 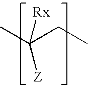
or [R¹—X₁—Y—C(O)—CH₂Z],
wherein
X₁, Y, and Z are as defined above,
Rx is C(O)O(R¹), C(O)N(R²)₂, OC(O)(R¹), SO₂(R¹), O(R¹), halide, or R¹;
each R¹ is independently H, CₙH₂ₙ₊₁, CₙH₂ₙ—CH(O)CH₂, [CH₂CH₂O]ᵢR⁴, [CₙC₂ₙ]N(R⁴)₂ or [CₙH₂ₙ]CₙF₂ₙ₊₁,
n is 1 to 40,
R⁴ is H
s=0 to 40,
i=1 to 200,
each R² is independently H, or CₜH₂ₜ₊₁ wherein t is 1 to 20,
each R³ is independently H, COOR¹, halogen, N(R¹)₂, OR¹, SO₂NHR¹, CH═CH₂, or SO₃M,
M is H, alkali metal salt, alkaline earth metal salt, or ammonium.

15. The method of claim 13 or 14 wherein the composition is applied as an aqueous dispersion or solution.

16. The method of claim 13 or 14 wherein the composition is applied by means of exhaustion, spray, foam, flex-nip, nip, pad, kiss-roll, beck, skein, winch, liquid injection, overflow flood, brush, roll, spray or immersion.

17. The method of claim 13 or 14 wherein the composition is applied in the presence of at least one of
A) an agent which provides a surface effect which is no iron, easy to iron, shrinkage control, wrinkle free, permanent press, moisture control, softness, strength, anti-slip, antistatic, anti-snag, anti-pill, stain repellency, stain release, soil repellency, soil release, water repellency, oil repellency, odor control, antimicrobial, or sun protection,
B) a surfactant, antioxidant, light fastness agent, color fastness agent, water, pH adjuster, cross linker, wetting agent, extender, foaming agent, processing aid, lubricant, blocked isocyanate, nonfluorinated and extenders, or
C) combinations thereof.

18. A substrate to which has been applied a composition of Formula 1
[R_{f}—X₁-A-X₁—Y—C(O)—CZCH₂]ₘ—[W_{q}]ₚ Formula 1
wherein
R_{f} is a straight or branched perfluoroalkyl group having from about 2 to about 20 carbon atoms, or a mixture thereof, which is optionally interrupted by at least one oxygen atom,
each X₁ is independently an organic divalent linking group having from about 1 to about 20 carbon atoms, optionally containing a triazole, oxygen, nitrogen, or sulfur, or a combination thereof,
A is a 1,2,3-triazole,
Y is O or N(R)₂ wherein R is H or C₁ to C₂₀ alkyl,
Z is H, a straight or branched alkyl group having from about 1 to about 4 carbon atoms, or halide,
m is a positive integer,
q is zero or a positive integer,
p is zero or a positive integer, and
W is 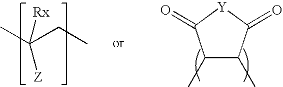
or [R¹—X₁—Y—C(O)—CH₂Z],
wherein
X₁, Y, and Z are as defined above,
Rx is C(O)O(R¹), C(O)N(R²)₂, OC(O)(R¹), SO₂(R¹), C₆(R³)₅, O(R¹), halide, or R¹;
each R¹ is independently H, CₙH₂ₙ₊₁, CₙH₂ₙ—CH(O)CH₂, [CH₂CH₂O]ᵢR⁴, [CₙC₂ₙ]N(R⁴)₂ or [CₙH₂ₙ]CₙF₂ₙ₊₁,
n is 1 to 40,
R⁴ is H or CₛH₂ₛ₊₁,
s=0 to 40,
i=1 to 200,
each R² is independently H, or CₜH₂ₜ₊₁ wherein t is 1 to 20,
each R³ is independently H, COOR¹, halogen, N(R¹)₂, OR¹, SO₂NHR¹, CH═CH₂, or SO₃M,
M is H, alkali metal salt, alkaline earth metal salt, or ammonium.

19. The substrate of claim 18 comprising a fibrous substrate or a hard surface substrate.

20. The substrate of claim 19 which is a fiber, yarn, fabric, fabric blend, textile, nonwoven, carpet, paper or leather.

21. The substrate of claim 19 which is selected from the group consisting of a polyamide, nylon, wool, polyester, polyolefin, polyaramid, acrylic, wool, cotton, jute, sisal, sea grass, coir, and blends thereof.

22. The substrate of claim 19 which is stone, masonry, concrete, unglazed tile, brick, porous clay, granite, limestone, grout, mortar, marble, wood, gypsum board, terrazzo, and composite materials.
